(19) United States
(12) Patent Application Publication
(10) Pub. No.: US 2025/0259392 A1
(43) Pub. Date: Aug. 14, 2025

(54) CAMERA-SPACE HAND MESH PREDICTION WITH DIFFERENTIAL GLOBAL POSITIONING

(71) Applicant: Niantic, Inc., San Francisco, CA (US)

(72) Inventors: Pierre Eugene Valassakis, London (GB); Guillermo Garcia-Hernando, London (GB)

(21) Appl. No.: 19/052,050

(22) Filed: Feb. 12, 2025

(30) Foreign Application Priority Data
Feb. 12, 2024 (GR) 20240100094

(51) Int. Cl. G06T 17/20; G06T 3/40

(52) U.S. Cl. CPC G06T 17/20; G06T 3/40

(57) ABSTRACT

An image of a hand is captured by a camera. The captured image is rectified by establishing a canonical camera space and mapping predictions back to an original camera space. A set of 2D keypoints, a set of root-relative vertices, and a set of weights are predicted based on the rectified image. Using the set of root-relative vertices, a set of 3D keypoints that correspond to the set of 2D keypoints are obtained. A global camera space hand mesh prediction is generated in 3D space based on the set of 2D keypoints, the set of weights, and the set of 3D keypoints. A virtual element is output in a virtual space based on the generated global camera space hand mesh prediction.

### BACKGROUND

### 1. Technical Field

The subject matter described relates generally to hand pose estimation, and, in particular, to camera-space 3D hand mesh prediction.

### 2. Problem

Predicting 3D hand meshes from single-view RGB images is useful in augmented and virtual reality applications, such as virtual try-on experiences, human digitization, and gaming. While there has been significant progress in recent years, hand mesh prediction remains a challenging problem primarily due to its highly articulated structure, self-occlusions, annotation difficulty, and 2D-to-3D scale and depth ambiguity. Most existing approaches in hand mesh and pose estimation rely on predicting root-relative hand meshes, i.e., 3D hand meshes in coordinates relative to a pre-defined root joint, such as the wrist, as opposed to predicting in a global camera space. Also, the existing techniques typically require large amounts of training data and associated model training that leads to excessive consumption of computing resources including storage requirements, network bandwidth, and processing power.

### SUMMARY

This disclosure pertains to predicting camera-space hand meshes from single RGB images for enabling realistic hand interactions in 3D virtual and augmented worlds. Most conventional approaches in monocular RGB-based camera-space 3D hand mesh and pose estimation follow a two-stage approach: (1) a first stage in which, given a cropped image of the hand, predict meshes in root-relative coordinates, and (2) a second separate and independent stage in which the predicted root-relative coordinates are lifted into camera space, often resulting in the loss of valuable contextual and scale information. To prevent the loss of these cues, techniques disclosed herein look to unify these two stages into an end-to-end solution. This disclosure enables back-propagation from camera space outputs to the rest of the network through a differentiable global positioning (DGP) module. The DGP module enables the backpropagation of gradients directly from camera space outputs to the rest of the network, using a set of 2D-3D correspondences defined by 2D keypoint predictions and root-relative 3D hand mesh predictions. Additionally, this disclosure includes an image rectification module that harmonizes the training dataset and the input image as if they were acquired with the same camera, helping to alleviate the inherent scale-depth ambiguity of the problem.

In one embodiment, a computer-implemented method according to the present disclosure includes a plurality of steps. The plurality of steps includes a step of accessing an image of a hand captured by a camera, and a step of predicting a set of 2D keypoints and a set of root-relative 3D vertices based on the image. In addition, the steps further include a step of obtaining, using the set of root-relative 3D vertices, a set of root-relative 3D keypoints that correspond to the set of 2D keypoints, and generating a global camera space mesh prediction of the hand in 3D space based on the set of 2D keypoints and the set of root-relative 3D keypoints. Still further, the steps include a step of outputting a virtual element in a virtual space based on the global camera space mesh prediction of the hand.

In some embodiments, the image is a single RGB image, and the method also includes a step of rectifying the image by establishing a canonical camera space and mapping predictions back to an original camera space, wherein the set of 2D keypoints and the set of root-relative 3D vertices are predicted using the rectified image. The step of rectifying the image may include a step of resizing the image with a ratio that converts camera parameters to an original set of camera parameters.

In some embodiments, the method also includes a step of predicting a set of weights based on the rectified image, wherein each weight of the set of weights represents a confidence in a prediction of a corresponding keypoint of the set of 2D keypoints, the set of weights accounting for keypoint landmark correspondence inaccuracy due to, for example, occlusion of the hand in the image. The step of obtaining the set of root-relative 3D keypoints that correspond to the set of 2D keypoints may include a step of accessing a 3D keypoint regressor matrix defining keypoint landmarks on the hand as a linear combination of hand mesh vertices; and a step of using the 3D keypoint regressor matrix to obtain the set of root-relative 3D keypoints based on the set of root-relative 3D vertices.

In some embodiments, the global camera space mesh prediction of the hand is a camera-space vertex prediction that can be projected into 2D using a pinhole camera perspective projection. The method may further include a step of predicting a global translation in camera space based on the set of 2D keypoints, the set of root-relative 3D keypoints, and the set of weights; and a step of generating the global camera space mesh prediction of the hand in 3D space based on the global translation and the set of root-relative 3D vertices.

In some embodiments, the method may also include a step of identifying from the set of 2D keypoints, a subset of 2D keypoints that belong to a wrist of the hand of a user; a step of determining a correspondence between keypoints in a 3D mesh template of a human wrist and keypoints in the subset of 2D keypoints that belong to the wrist of the hand of the user; and a step of predicting a 3D mesh of the wrist of the hand of the user based on the correspondence. The step of outputting the virtual element in the virtual space based the global camera space mesh prediction of the hand may include a step of placing the virtual element on the wrist of the hand of the user based on the global camera space mesh prediction of the hand and the 3D mesh of the wrist.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for camera-space 3D hand mesh prediction, according to one embodiment.

FIG. 4 is a block diagram of the hand mesh prediction module shown in FIG. 3, according to one embodiment.

FIG. 5 illustrates the architecture and image processing pipeline of the hand mesh prediction module shown in FIG. 3, according to one embodiment.

FIG. 6 is a flowchart of a process for generating a camera-space 3D mesh of the hand and a wrist, according to one embodiment.

FIG. 7 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where camera-space 3D hand mesh prediction is desirable. In addition, the inherent flexibility of computer-based systems allows for a great variety of possible configurations, combinations, and divisions of tasks and functionality between and among the components of the system.

### Example Location-Based Parallel Reality Game

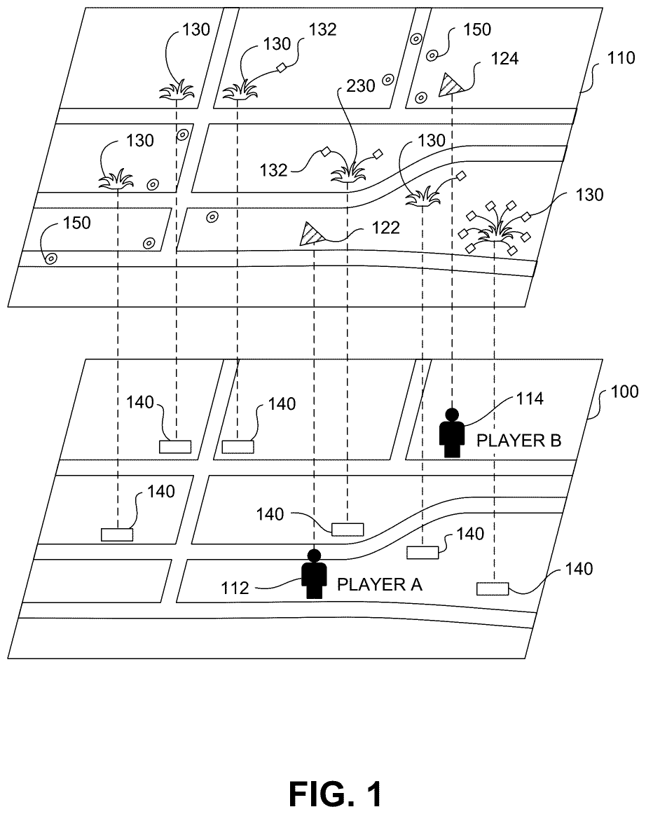

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

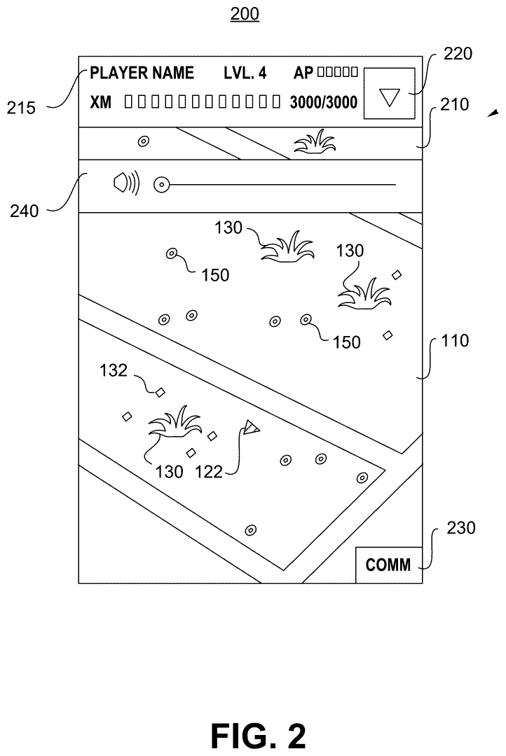

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

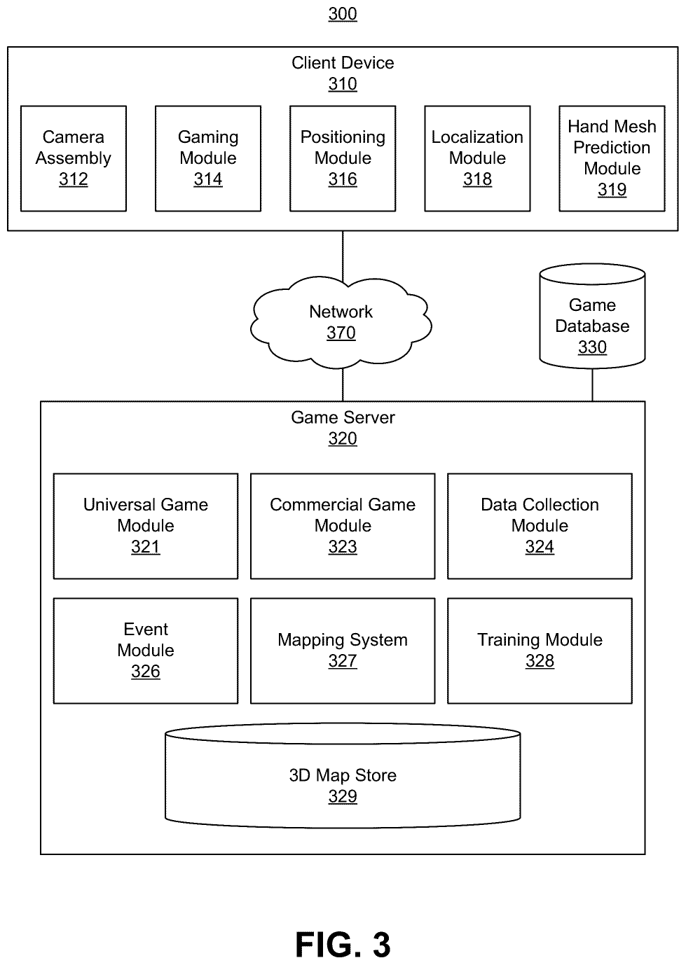

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, a localization module 318, and a hand mesh prediction module 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video. In some embodiments, the camera assembly 312 may capture an image (e.g., live image or through image) of a hand of a user of the client device 310. The captured image may be processed and input to the hand mesh prediction module 319 to generate and overlay a live 3D mesh of the hand and the wrist of the user to enable different virtual experiences related to augmented reality, virtual reality, mixed reality, parallel reality, and the like. For example, the virtual experiences may include virtual try-on experiences, office work using an AR or mixed-reality headset, gaming, and the like.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The hand mesh prediction module 319 performs camera space 3D hand mesh predictions based on an image captured by the camera assembly 312. The 3D hand mesh predicted by the hand mesh prediction module 319 may be provided to the gaming module 314 to enable the gaming module 314 to present virtual content overlaid on a real-world image of a hand of the user of the client device 310 (e.g., by displaying virtual elements in conjunction with a real-time feed that includes a hand from the camera assembly 312 on a display) to enable, e.g., virtual try-on experiences, human digitization, gaming experiences, and office work when using AR or mixed-reality headsets. For example, an image captured by the camera assembly 312 may be a single RGB image. The RGB image may be stored in a memory (e.g., temporary memory, storage disk) of the client device 310. The stored image may be accessed by the hand mesh prediction module 319 to perform the hand mesh prediction based on the accessed image. One or more processes (e.g., rectification by an image rectification module) may be performed on the accessed image prior to performing the hand mesh prediction. One or more models that form the hand mesh prediction pipeline of the hand mesh prediction module 319 may be trained in advance (e.g., by the training module 328) and provided to the client device 310 in advance.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, a training module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The training module 328 trains the one or more models (e.g., neural networks) of the hand mesh prediction module 319 for use by client devices 310. Although the training module 328 is shown as part of the game server 320 for convenience, the training module 328 may be trained and provided to client devices 310 by another system or systems. For example, a differentiable global positioning model, a wrist finding model, and/or a root-relative model of the hand mesh prediction module 319 may be trained by a development system and incorporated in an application that is downloaded to client devices 310 from an app store.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

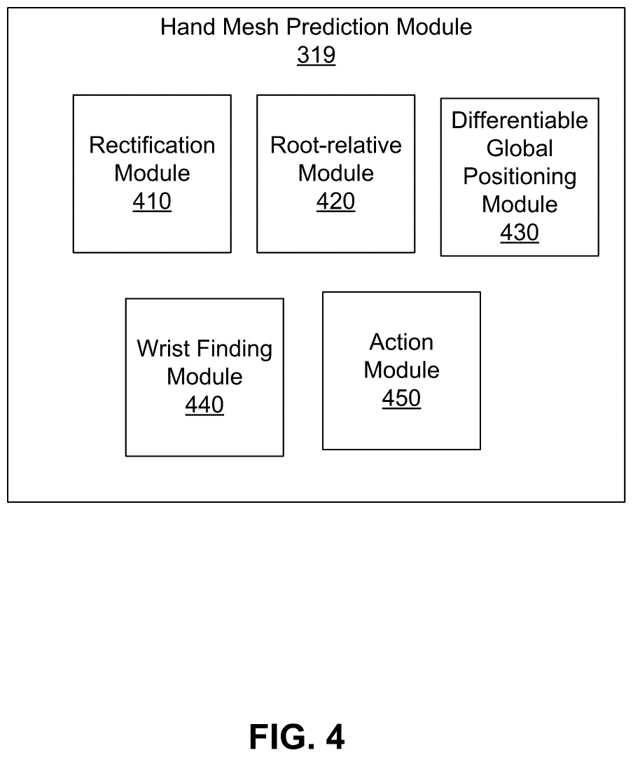

FIG. 4 is a block diagram of the hand mesh prediction module 319 shown in FIG. 3, according to one embodiment. In the embodiment shown in FIG. 4, the hand mesh prediction module 319 includes a rectification module 410, a root-relative module 420, a differentiable global positioning (DGP) module 430, and a wrist finding module 440. In other embodiments, the hand mesh prediction module 319 contains different or additional elements. In addition, the functions may be distributed among the elements in a different manner than described.

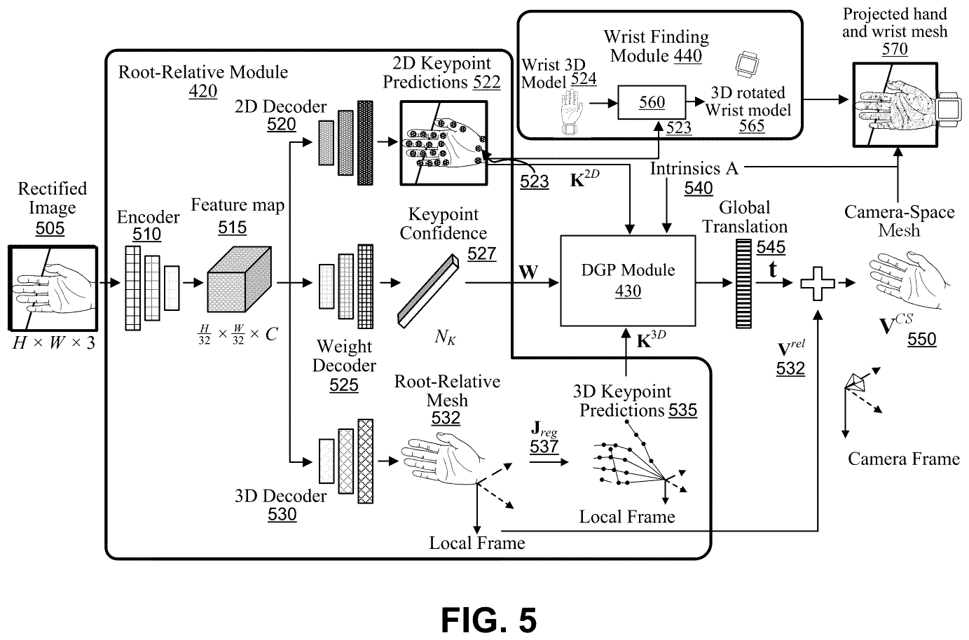

FIG. 5 illustrates the architecture and image processing pipeline of the hand mesh prediction module 319 of FIG. 3, according to one embodiment. The architecture and image processing pipeline of the hand mesh prediction module 319 illustrated in FIG. 5 is for illustration only. Other embodiments of the hand mesh prediction module 319 may adopt a different architecture and/or image processing pipeline.

Referring back to FIG. 4, the rectification module 410 may rectify an image (e.g., single RGB image captured by the camera assembly 312 of the client device 310) that is input to the image processing pipeline by establishing a canonical camera space and mapping predictions back to an original camera space.

That is, the rectification module 410 establishes a canonical camera space and transforms the training data into that space. During inference, the rectification module 410 rectifies the image (e.g., an image captured by camera assembly 312 and input to the rectification module 410) and provides the rectified image to the root-relative module 420 for 3D hand and/or wrist mesh prediction. FIG. 5 illustrates at 505 that an image rectified by the image rectification module 410 is input to the root-relative module 420 for feature extraction and further downstream processing by the image processing pipeline (e.g., predicting a set of 2D keypoints and a set of root-relative 3D vertices using the rectified image). Predictions by the pipeline are mapped back to the original camera space.

The original set of camera parameters is defined by {f, u₀, v₀} where f represents the focal length (we assume fₓ=f_{y}=f) and u₀ and v₀ be the principal points. The rectification module 410 may resize the input image I with the ratio

$${ω}_{r} = \frac{{f}^{c}}{f}$$

which converts the camera parameters to {f^{c}, ωᵣu₀, ωᵣv₀}. In some embodiments, the rectification module 410 may further rectify the principal point to be the center of the hand crop, resulting in the final canonical intrinsics matrix A defined by {f^{c}, H/2, W/2} where f^{c} is the canonical focal length and the rectified principal point is the center of the input image. The image rectification step by the rectification module 410 may be performed both during training and testing, and the inverse transformation may be applied to project into the original image during inference.

Returning to FIG. 4, the root-relative module 420 predicts a set of 2D keypoints and a set of root-relative 3D vertices based on the image. In some embodiments, the root-relative module 420 may also predict a set of weights based on the rectified image. Each weight of the set of weights may represent a confidence in a prediction of a corresponding keypoint of the set of 2D keypoints. The set of weights may account for keypoint landmark correspondence inaccuracy due to occlusion of the hand in the image.

For example, as illustrated in the pipeline of FIG. 5, the root-relative module 420 may take an image 505 Iϵ [symbol] as an input to a convolutional encoder 510 to produce a feature map 515 Fϵ [symbol] . The feature map 515 F may then be input to three separate decoder heads: a 2D decoder 520 outputting a set of N_{K} 2D keypoints K^{2D}, a 3D decoder 530 outputting the root-relative vertices V^{rel}, and a weights decoder 525 outputting a set of confidence weights W.

That is, as shown in FIG. 5, starting from a single RGB image 505 Iϵ [symbol] , the root-relative module 420 may predict a set of 2D keypoints 522, that can be joints or other landmarks of the hand input at 505, K^{2D}={kᵢ^{2D}}ᵢ₌₁^{N}^{_{K}}, a set of root-relative 3D vertices 532 V^{rel}={vᵢ^{rel}}ᵢ₌₁^{N}^{_{V}}, and a set of weights 527 W={wᵢ}ᵢ₌₁^{N}^{_{K}}, that represent the confidence in the predictions of each landmark. As shown in FIG. 5, the set of 2D keypoints 522 predicted by 2D decoder 520 of the root-relative module 420 may include hand joints or other landmarks such as user wrist keypoints.

In cases such as occlusion or self-occlusion of parts of the hand, the occluded parts may result in more uncertain keypoint placements at 522 by the 2D decoder 520. To address this issue, the root-relative module 420 may apply a weighted variant 527 with the weight decoder 525. That is, the weight decoder 527 determines a confidence score wᵢ associated with each keypoint correspondence at 522 and constructs a weight matrix by duplicating each weight once and placing them in a diagonal matrix W=diag([w₁, w₁, w₂, w₂ . . . w_{N}_{_{K}}, w_{N}_{_{K}}]).

Starting from the feature map 515 Fϵ [symbol] , the weight decoder 525 may perform a series of 1×1 convolutions to obtain a new feature map F_{W}ϵ [symbol] . The weight decoder 525 may then use the 2D positions provided by K^{2D} 522 in order to grid sample a set of N_{K}, D-dimensional features 527, which are concatenated in D×N_{K} dimensional latent vector Z_{W} which is then processed through a set of dense layers with leaky ReLU activations, and the final output is processed through a sigmoid function, forcing the confidence weights to be in [0,1].

The root-relative module 420 may further obtain, using the set of root-relative 3D vertices 532, a set of root-relative 3D keypoints 535 that correspond to the set of 2D keypoints 522. To obtain the set of root-relative 3D keypoints 535, the root-relative module 420 may access a 3D keypoint regressor matrix 537 defining keypoint landmarks on the hand as a linear combination of hand mesh vertices. The root-relative module 420 may then use the 3D keypoint regressor matrix 537 to obtain the set of root-relative 3D keypoints 535 based on the set of root-relative 3D vertices 532.

That is, as shown in FIG. 5, the root-relative module 420 may obtain K^{3D}={kᵢ^{3D}}ᵢ₌₁^{N}^{_{K}} a set of root-relative 3D keypoints 535 on the hand model that correspond to the 2D keypoints K^{2D} 522. To obtain K^{3D} 535, the root-relative module 420 may access a 3D keypoint regressor 537 J_{reg}:V^{rel}→K^{3D}. J_{reg} may be in the form of a matrix, which defines keypoints landmarks on the hand as a linear combination of hand mesh vertices, and may be provided with publicly available mesh models.

Returning to FIG. 4, the DGP module 430 may generate a global camera space mesh prediction of the hand in 3D space based on the set of 2D keypoints and the set of root-relative 3D keypoints. That is, as shown in FIG. 5, the DGP module 430 takes as input K^{3D} 535, K^{2D} 522, and camera intrinsics A 540 as input, and outputs the global camera-space translation t 545 in a differentiable manner.

To obtain the global translation 545 t=[τ_{X}, τ_{y}, τ_{z}]^{T} in a differentiable way, the DGP module 430 adapts a technique based on Direct Linear Transform (DLT). Firstly, by design K^{3D} 535 and K^{2D} 522 give a set of 2D-3D correspondences [symbol] ={(kᵢ^{3D}, kᵢ^{2D})}ᵢ₌₁^{N}^{_{K}}, with kᵢ^{3D}=[xᵢ, yᵢ, zᵢ]^{T} and kᵢ^{2D}=[uᵢ, vᵢ]^{T}. Additionally, the 3D keypoints K^{3D} 535 are expressed in a frame that shares the same orientation as the camera frame, with only the global root translation missing to map root-relative keypoint coordinates to camera-space coordinates. Assuming a pinhole camera model with intrinsic parameters A 540, the projection equation is expressed as:

$${d}_{i} [ \begin{matrix}{u}_{i} \\ {v}_{i} \\ 1\end{matrix} ] = Λ [ \begin{matrix}1 & 0 & 0 \vert {τ}_{x} \\ 0 & 1 & 0 \vert {τ}_{y} \\ 0 & 0 & 1 \vert {τ}_{z}\end{matrix} ] [ \begin{matrix}{x}_{i} \\ {y}_{i} \\ {z}_{i} \\ 1\end{matrix} ] , \qquad ( 1 )$$

with dᵢ the depth value of keypoint i. Expanding and re-arranging, this gives a system of linear equations that can be written in the following form:

$$[ \begin{matrix}- 1 & 0 & {u}_{i}^{′} \\ 0 & - 1 & {v}_{i}^{′}\end{matrix} ] [ \begin{matrix}{τ}_{x} \\ {τ}_{y} \\ {τ}_{z}\end{matrix} ] = [ \begin{matrix}{x}_{i} - {z}_{i} {u}_{i}^{′} \\ {y}_{i} - {z}_{i} {v}_{i}^{′}\end{matrix} ] , \qquad ( 2 )$$

where

$$[ \begin{matrix}{u}_{i}^{′} \\ {v}_{i}^{′} \\ 1\end{matrix} ] = {Λ}^{- 1} [ \begin{matrix}{u}_{i} \\ {v}_{i} \\ 1\end{matrix} ] .$$

Since Equation 2 is obtained considering a single keypoint correspondence, and since we have three unknowns, it is under-constrained. Using all the keypoints in the correspondence set, Equation 2 can be re-written as

$$[ \begin{matrix}- 1 & 0 & {u}_{1}^{′} \\ 0 & - 1 & {v}_{1}^{′} \\ & ⋮ & \\ 0 & - 1 & {v}_{{N}_{K}}^{′}\end{matrix} ] t = [ \begin{matrix}{x}_{1} - {z}_{1} {u}_{1}^{′} \\ {y}_{1} - {z}_{1} {v}_{1}^{′} \\ ⋮ \\ {y}_{{N}_{K}} - {z}_{{N}_{K}} {v}_{{N}_{K}}^{′}\end{matrix} ] \qquad ( 3 )$$

which has the form At=B. To solve for t, the DGP module 430 considers the least-squares solutions t*=arg minₜ∥At−B∥², which can be obtained in closed-form:

$${t}^{*} = {( {A}^{T} A )}^{- 1} {A}^{T} B . \qquad ( 4 )$$

The DGP module 430 first uses the network outputs to build the matrices A and B, and then uses the linear least-squares solution to solve for the translation. Since all the operations involved are differentiable, the hand mesh prediction module 319 can use this translation to obtain and backpropagate through camera-space vertex predictions, fully incorporating the root-finding task in an end-to-end training pipeline.

While the above solution allows the hand mesh prediction module 319 to incorporate root finding into an end-to-end differentiable pipeline, it does not provide for any outlier filtering or keypoint selection mechanism that could help filter out more uncertain correspondences. To address this issue, the DGP module 430 uses the weights W 527 in addition to the root-relative 3D keypoints K^{3D} 535 and the 2D keypoints K^{2D} 522, in order to predict a global translation tϵ [symbol] in camera-space. That is, the DGP module 430 predicts a global translation in camera space based on the set of 2D keypoints, the set of root-relative 3D keypoints, and the set of weights; and generates the global camera space mesh prediction of the hand in 3D space based on the global translation and the set of root-relative 3D vertices.

That is, the DGP module 430 generates a weighted least-squares minimisation t*=arg minₜ∥W(At −B)∥², with closed-form solution:

$${t}^{*} = {( {A}^{T} {W}^{2} A )}^{- 1} {A}^{T} {W}^{2} B . \qquad ( 5 )$$

The global translation 545 predicted as described above by the DGP module 430 can then be used to obtain the camera-space vertex predictions 550 V^{cs}={vᵢ^{cs}}ᵢ₌₁^{N}^{_{V}}, with

$${v}_{i}^{cs} = {v}_{i}^{rel} + t . \qquad ( 6 )$$

That is, using J_{reg} 537, the root-relative module 420 obtains the root-relative 3D keypoints K^{3D} 535, forming a set of 2D-3D correspondences [symbol] =JV {(uᵢ, vᵢ, xᵢ, yᵢ, zᵢ)}ᵢ₌₁^{N}^{_{K}}. Using [symbol] , the DGP module 430 constructs the matrices A and B, and obtains t 545 using Equations 4 and 5. Finally, as shown in the image processing pipeline in FIG. 5, t 545, V^{rel} 532, and K^{3D} 535 are used to obtain the camera-space vertices V^{cs} 550 and camera-space keypoints, following Equation 6, and use all of the mentioned network outputs to construct training losses.

The camera-space vertex predictions 550 can finally be used to project the mesh into 2D 570 using a pinhole camera perspective projection. The pipeline shown in FIG. 5, enables including the global root translation 545 and the resulting mesh projections 570 as part of the neural network training. Incorporating hand root prediction as part of the training this way has the benefit of avoiding the accumulation of errors that can occur when using two independent processes for root-relative predictions and root-finding. Also, the pipeline illustrated in FIG. 5 is agnostic to the particular designs used to obtain the predictions for V^{rel} 532, K 522, 535, and W 527.

Returning to FIG. 4, the wrist finding module 440 may identify from the set of 2D keypoints, a subset of 2D keypoints that belong to a wrist of the hand of a user, and determine a correspondence between keypoints in a 3D mesh template of a human wrist and keypoints in the subset of 2D keypoints that belong to the wrist of the hand of the user. The wrist finding module 440 may predict a 3D mesh of the wrist of the hand of the user based on the correspondence.

As shown in the pipeline of FIG. 5, the wrist finding module 440, may identify from the set of 2D keypoints 522, a subset of 2D keypoints 523 that belong to a wrist of the hand of a user. The wrist finding module 440 may further take as input, a template wrist 3D model 524 and employ a pose estimation algorithm 560 such as perspective-n-point (PnP) to determine a 3D rotated wrist model 565 of the wrist of the hand image input at 505. That is, the pose estimation module 560 may determine a correspondence between keypoints in a 3D mesh template of a human wrist 524 and keypoints in the subset of 2D keypoints 523 that belong to the wrist of the hand of the user, and predicting a 3D mesh 565 of the wrist of the hand of the user based on the correspondence.

The action module 450 of FIG. 4 outputs a virtual element in a virtual space based on the global camera space mesh prediction of the hand 550 and/or the wrist 565, as shown in FIG. 5. For example, the action module 450 places the virtual element on the wrist of the hand of the user (as shown at 570 in FIG. 5) based on the global camera space mesh prediction 550 of the hand and the 3D mesh of the wrist 565. In the example shown in FIG. 5 at 570, the action module 450 enables a virtual try-on experience for the user by rendering a watch based on the predicted global camera space mesh of the hand 550 and the 3D rotated wrist model 565. The user manipulating their hand and wrist will cause the rendered watch to be accurately re-rendered in real-time based on the functionality provided by the hand mesh prediction module 319, thereby enabling the user to fully appreciate a look and feel of the watch as if they were trying it on in the real world.

### Example Methods

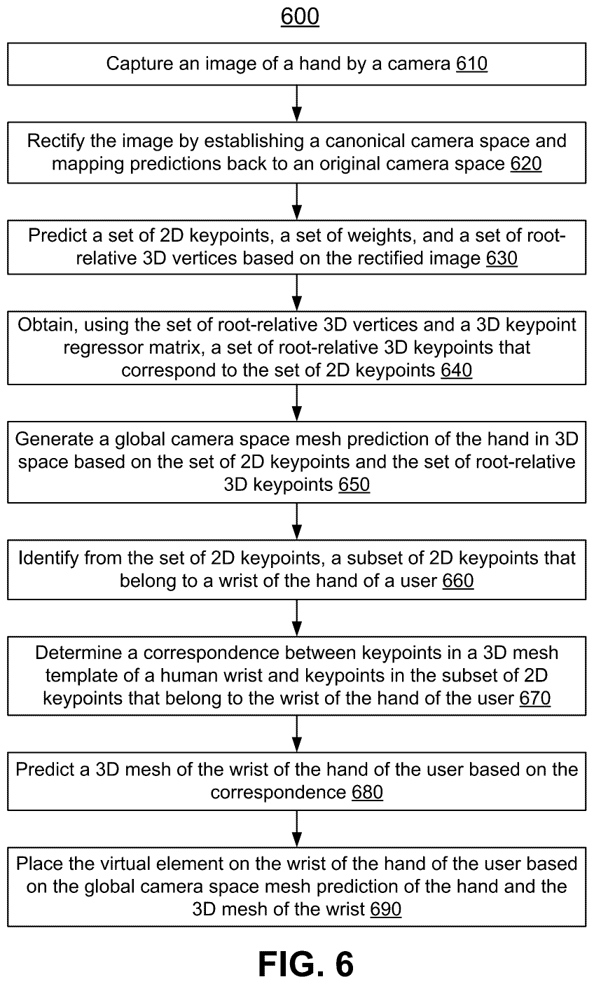

FIG. 6 is a flowchart of a process 600 for generating a camera-space 3D mesh of the hand and a wrist, according to one embodiment. The steps of FIG. 6 are illustrated from the perspective of the client device 310 performing the method 600. However, some or all of the steps may be performed by other entities or components. In addition, some embodiments may perform the steps in parallel, perform the steps in different orders, not perform all of the steps, perform different steps, or perform additional steps.

In the embodiment shown, the method 600 begins when the client device 310 captures 610 an image (e.g., RBG image) of a hand by a camera (e.g., the camera assembly 312). The client device 310 may rectify 620 (e.g., with the rectification module 410 in FIG. 4; rectified image 505 in FIG. 5) the image captured at block 610 by establishing a canonical camera space and mapping predictions back to an original camera space.

The client device 310 may predict 630 (e.g., using the root-relative module 420 in FIG. 4) a set of 2D keypoints (e.g., 2D keypoint predictions 522 in FIG. 5), a set of weights (e.g., keypoint confidence 527 in FIG. 5), and a set of root-relative 3D vertices (e.g., root-relative mesh 532 in FIG. 5) based on the rectified image (e.g., image 505 in FIG. 5).

The client device 310 may obtain 640 (e.g., using the root-relative module 420 in FIG. 4), using the set of root-relative 3D vertices (e.g., root-relative mesh 532 in FIG. 5) and a 3D keypoint regressor matrix (e.g., J_{reg} 537 in FIG. 5), a set of root-relative 3D keypoints (e.g., 3D keypoint predictions 535 in FIG. 5) that correspond to the set of 2D keypoints (e.g., 2D keypoint predictions 522 in FIG. 5).

The client device 310 may generate 650 (e.g., using DGP module 430) a global camera space mesh prediction (e.g., camera-space mesh 550 in FIG. 5) of the hand in 3D space based on the set of 2D keypoints and the set of root-relative 3D keypoints. The client device 310 may identify 660 (e.g., using wrist finding module 440) from the set of 2D keypoints (e.g., 2D keypoint predictions 522 in FIG. 5), a subset of 2D keypoints (e.g., subset keypoints 523 in FIG. 5) that belong to a wrist of the hand of a user.

The client device 310 may determine 670 (e.g., using pose estimation module 560 in FIG. 5) a correspondence between keypoints in a 3D mesh template (e.g., wrist 3D model 524 in FIG. 5) of a human wrist and keypoints in the subset of 2D keypoints (e.g., subset keypoints 523 in FIG. 5) that belong to the wrist of the hand of the user.

The client device 310 may predict 680 a 3D mesh (e.g., 3D rotated wrist model 656 in FIG. 5) of the wrist of the hand of the user based on the correspondence. The client device 310 may place 690 (e.g., using action module 450) a virtual element (e.g., watch shown at 570 in FIG. 5) on the wrist of the hand of the user based on the global camera space mesh prediction of the hand (e.g., camera-space mesh 550 in FIG. 5) and the 3D mesh of the wrist (e.g., 3D rotated wrist model 656 in FIG. 5).

### Example Computing System

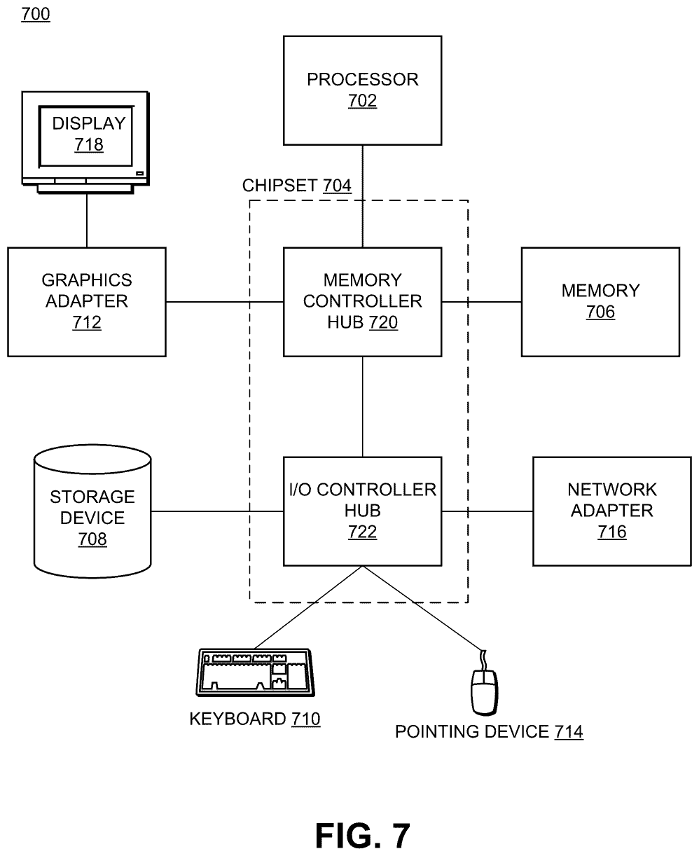

FIG. 7 is a block diagram of an example computer 700 suitable for use as a client device 310 or game server 320. The example computer 700 includes at least one processor 702 coupled to a chipset 704. References to a processor (or any other component of the computer 700) should be understood to refer to any one such component or combination of such components working cooperatively to provide the described functionality. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touch-screen, or other type of pointing device, and may be used in combination with the keyboard 710 (which may be an on-screen keyboard) to input data into the computer system 700. The graphics adapter 712 displays images and other information on the display 718. The network adapter 716 couples the computer system 700 to one or more computer networks, such as network 370.

The types of computers used by the entities of FIGS. 3 and 4 can vary depending upon the embodiment and the processing power required by the entity. For example, the game server 320 might include multiple blade servers working together to provide the functionality described. Furthermore, the computers can lack some of the components described above, such as keyboards 710, graphics adapters 712, and displays 718.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing an image of a hand captured by a camera;
predicting a set of 2D keypoints and a set of root-relative 3D vertices based on the image;
obtaining, using the set of root-relative 3D vertices, a set of root-relative 3D keypoints that correspond to the set of 2D keypoints;
generating a global camera space mesh prediction of the hand in 3D space based on the set of 2D keypoints and the set of root-relative 3D keypoints; and
outputting a virtual element in a virtual space based on the global camera space mesh prediction of the hand.

2. The computer-implemented method of claim 1, wherein the image is a single RGB image, and wherein the method further comprises:
rectifying the image by establishing a canonical camera space and mapping predictions back to an original camera space, wherein the set of 2D keypoints and the set of root-relative 3D vertices are predicted using the rectified image.

3. The computer-implemented method of claim 2, wherein rectifying the image comprises:
resizing the image with a ratio that converts camera parameters to an original set of camera parameters.

4. The computer-implemented method of claim 2, further comprising:
predicting a set of weights based on the rectified image, wherein each weight of the set of weights represents a confidence in a prediction of a corresponding keypoint of the set of 2D keypoints, the set of weights accounting for keypoint landmark correspondence inaccuracy due to occlusion of the hand in the image.

5. The computer-implemented method of claim 4, wherein obtaining the set of root-relative 3D keypoints that correspond to the set of 2D keypoints comprises:
accessing a 3D keypoint regressor matrix defining keypoint landmarks on the hand as a linear combination of hand mesh vertices; and
using the 3D keypoint regressor matrix to obtain the set of root-relative 3D keypoints based on the set of root-relative 3D vertices.

6. The computer-implemented method of claim 5, wherein the global camera space mesh prediction of the hand is a camera-space vertex prediction that can be projected into 2D using a pinhole camera perspective projection, and wherein the method further comprises:
predicting a global translation in camera space based on the set of 2D keypoints, the set of root-relative 3D keypoints, and the set of weights; and
generating the global camera space mesh prediction of the hand in 3D space based on the global translation and the set of root-relative 3D vertices.

7. The computer-implemented method of claim 1, further comprising:
identifying from the set of 2D keypoints, a subset of 2D keypoints that belong to a wrist of the hand of a user;
determining a correspondence between keypoints in a 3D mesh template of a human wrist and keypoints in the subset of 2D keypoints that belong to the wrist of the hand of the user; and
predicting a 3D mesh of the wrist of the hand of the user based on the correspondence.

8. The computer-implemented method of claim 7, wherein outputting the virtual element in the virtual space based the global camera space mesh prediction of the hand comprises:
placing the virtual element on the wrist of the hand of the user based on the global camera space mesh prediction of the hand and the 3D mesh of the wrist.

9. A non-transitory computer-readable medium storing instructions that, when executed by a computing system, cause the computing system to perform operations comprising:
accessing an image of a hand captured by a camera;
predicting a set of 2D keypoints and a set of root-relative 3D vertices based on the image;
obtaining, using the set of root-relative 3D vertices, a set of root-relative 3D keypoints that correspond to the set of 2D keypoints;
generating a global camera space mesh prediction of the hand in 3D space based on the set of 2D keypoints and the set of root-relative 3D keypoints; and
outputting a virtual element in a virtual space based on the global camera space mesh prediction of the hand.

10. The non-transitory computer-readable medium of claim 9, wherein the image is a single RGB image, and wherein the operations further comprise:
rectifying the image by establishing a canonical camera space and mapping predictions back to an original camera space, wherein the set of 2D keypoints and the set of root-relative 3D vertices are predicted using the rectified image.

11. The non-transitory computer-readable medium of claim 10, wherein rectifying the image comprises:
resizing the image with a ratio that converts camera parameters to an original set of camera parameters.

12. The non-transitory computer-readable medium of claim 10, wherein the operations further comprise:
predicting a set of weights based on the rectified image, wherein each weight of the set of weights represents a confidence in a prediction of a corresponding keypoint of the set of 2D keypoints, the set of weights accounting for keypoint landmark correspondence inaccuracy due to occlusion of the hand in the image.

13. The non-transitory computer-readable medium of claim 12, wherein obtaining the set of root-relative 3D keypoints that correspond to the set of 2D keypoints comprises:
accessing a 3D keypoint regressor matrix defining keypoint landmarks on the hand as a linear combination of hand mesh vertices; and
using the 3D keypoint regressor matrix to obtain the set of root-relative 3D keypoints based on the set of root-relative 3D vertices.

14. The non-transitory computer-readable medium of claim 13, wherein the global camera space mesh prediction of the hand is a camera-space vertex prediction that can be projected into 2D using a pinhole camera perspective projection, and wherein the operations further comprise:
predicting a global translation in camera space based on the set of 2D keypoints, the set of root-relative 3D keypoints, and the set of weights; and
generating the global camera space mesh prediction of the hand in 3D space based on the global translation and the set of root-relative 3D vertices.

15. The non-transitory computer-readable medium of claim 9, wherein the operations further comprise:
identifying from the set of 2D keypoints, a subset of 2D keypoints that belong to a wrist of the hand of a user;
determining a correspondence between keypoints in a 3D mesh template of a human wrist to keypoints in the subset of 2D keypoints that belong to the wrist of the hand of the user; and
predicting a 3D mesh of the wrist of the hand of the user based on the correspondence.

16. The non-transitory computer-readable medium of claim 15, wherein outputting the virtual element in the virtual space based the global camera space mesh prediction of the hand comprises:
placing the virtual element on the wrist of the hand of the user based on the global camera space mesh prediction of the hand and the 3D mesh of the wrist.

17. A client device for predicting a hand mesh, the client device comprising:
a display;
a camera;
one or more processors; and
memory storing instructions that, when executed by the one or more processors, cause the one or more processors to perform operations comprising:
accessing an image of a hand captured by the camera;
predicting a set of 2D keypoints and a set of root-relative 3D vertices based on the image;
obtaining, using the set of root-relative 3D vertices, a set of root-relative 3D keypoints that correspond to the set of 2D keypoints;
generating a global camera space mesh prediction of the hand in 3D space based on the set of 2D keypoints and the set of root-relative 3D keypoints; and
displaying, on the display, a virtual element in a virtual space based on the global camera space mesh prediction of the hand.

18. The client device of claim 17, wherein the operations further comprise:
identifying from the set of 2D keypoints, a subset of 2D keypoints that belong to a wrist of the hand of a user;
determining a correspondence between keypoints in a 3D mesh template of a human wrist to keypoints in the subset of 2D keypoints that belong to the wrist of the hand of the user; and
predicting a 3D mesh of the wrist of the hand of the user based on the correspondence.

19. The client device of claim 18, wherein outputting the virtual element in the virtual space based the global camera space mesh prediction of the hand comprises:
placing the virtual element on the wrist of the hand of the user based on the global camera space mesh prediction of the hand and based on the 3D mesh of the wrist.

20. The client device of claim 17, wherein the image is a single RGB image, and wherein the operations further comprise:
rectifying the image by establishing a canonical camera space and mapping predictions back to an original camera space, wherein the set of 2D keypoints and the set of root-relative 3D vertices are predicted using the rectified image.
